(19) United States
(12) Patent Application Publication
(10) Pub. No.: US 2025/0137719 A1
(43) Pub. Date: May 1, 2025

(54) ROOF INSULATION DRYING APPARATUS

(71) Applicants: Adam Capps, Nashville, TN (US); Christopher Herndon, Nashville, TN (US)

(72) Inventors: Adam Capps, Nashville, TN (US); Christopher Herndon, Nashville, TN (US)

(21) Appl. No.: 18/933,075

(22) Filed: Oct. 31, 2024

Related U.S. Application Data
(60) Provisional application No. 63/595,089, filed on Nov. 1, 2023.

(51) Int. Cl. F26B 3/04; F26B 9/00; F26B 23/00

(52) U.S. Cl. CPC F26B 3/04; F26B 9/003; F26B 23/001

(57) ABSTRACT

A roof insulation drying apparatus includes a hollow housing having an opening at its base and configured for placement on top of a roof vent on a roof, such that an interior volume of the housing is continuous with an interior volume of the roof vent, an aperture on a side of the housing, wherein said aperture faces a first direction that is approximately 45-degrees from the longitudinal axis of the roof vent, a planar surface at a top of the housing, a tubular adapter configured for securing the housing to the roof vent, the adapter comprising an outer diameter configured for securely fitting within the opening, and an inner diameter configured for securely fitting around the vent, a solar panel secured to the planar surface, and, a fan conductively coupled to the solar panel, such that the solar panel powers the fan.

### CROSS-REFERENCE TO RELATED APPLICATIONS

This patent application claims priority to provisional patent application 63/595,089 filed Nov. 1, 2023 and titled “Roof Insulation Drying Apparatus.” The subject matter of provisional patent application 63/595,089 is hereby incorporated by reference in its entirety.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### TECHNICAL FIELD

The technical field relates generally to the roofing industry and, more specifically, relates to the field of storm damage remediation for roofs and buildings in general.

### BACKGROUND

Roofs, especially those in areas prone to stormy weather, often suffer from damage that leads to the penetration of moisture. Roof damage may also be caused by natural decomposition of the roofing membrane and accidental punctures thereof. When water permeates a roof, the underlying insulation becomes wet, which can lead to a variety of problems. Wet insulation loses its thermal resistance properties, thereby reducing the energy efficiency of the insulated structure. Additionally, wet insulation provides a conducive environment for mold growth, which can result in health issues for the individuals using the building and further structural damage to the structure.

Traditional methods of addressing wet insulation involve either replacing the damaged insulation or manually drying it, both of which can be time-consuming and costly. There are also solutions like dehumidifiers and fans that can be placed to dry the insulation, but these often require an external power source, and their efficiency can be costly and limited, especially in situations where there's limited power access due to storm aftermath.

One existing product in the roofing industry is attic fans, which are mechanical ventilation devices installed in the attic space of a building. Attic fans are designed to expel hot air from the attic, replacing it with cooler outside air drawn through soffit vents or other intake points. This process helps reduce the attic temperature during warm months, thereby decreasing the cooling load on the building's HVAC system and improving overall energy efficiency. While attic fans promote air circulation within the attic, their primary function is thermal regulation rather than moisture remediation. Attic fans operate by removing heat accumulated in the attic space due to solar radiation on the roof surface but lack effectiveness in drying out wet insulation because the airflow generated by attic fans is generally insufficient to penetrate deeply into insulation materials, especially those located beneath the roof deck or within enclosed cavities.

Additionally, attic fans may inadvertently create negative pressure within the attic space, which can draw conditioned air from the living areas into the attic, leading to increased energy consumption and potential moisture problems elsewhere in the building. Moreover, the operation of attic fans typically relies on the building's electrical system, which may not be functional in the aftermath of a severe storm or power outage. This dependency on external power sources can hinder timely moisture remediation efforts when they are most needed.

Therefore, a need exists to overcome the problems with the prior art as discussed above, and particularly for a more efficient and economical way of remediating water damage to roofs.

### SUMMARY

A roof insulation drying apparatus is provided. This Summary is provided to introduce a selection of disclosed concepts in a simplified form that are further described below in the Detailed Description including the drawings provided. This Summary is not intended to identify key features or essential features of the claimed subject matter. Nor is this Summary intended to be used to limit the claimed subject matter's scope.

In one embodiment, a roof insulation drying apparatus is provided that solves the above-described problems. The roof insulation drying apparatus includes a hollow housing having an opening at its base and configured for placement on top of a roof vent on a roof, such that an interior volume of the housing is continuous with an interior volume of the roof vent, an aperture on a side of the housing, wherein said aperture faces a first direction that is approximately 45-degrees from the longitudinal axis of the roof vent, a planar surface at a top of the housing, wherein said planar surface faces a second direction that is approximately opposite the first direction, a tubular adapter configured for securing the housing to the roof vent, the adapter comprising an outer diameter configured for securely fitting within the opening, and an inner diameter configured for securely fitting around the vent, a solar panel secured to the planar surface, and, a fan conductively coupled to the solar panel, such that the solar panel powers the fan. In another embodiment, the tubular adapter further includes a portion having an outer diameter equivalent to an outer diameter of the opening;

### BRIEF DESCRIPTION OF THE DRAWINGS

The accompanying drawings, which are incorporated in and constitute a part of this disclosure, illustrate various example embodiments. In the drawings:

FIG. 1 depicts a top perspective view of a roof insulation drying apparatus, according to an embodiment.

FIG. 2 depicts a side view of the roof insulation drying apparatus, according to an embodiment.

FIG. 3 depicts a front view of the roof insulation drying apparatus, according to an embodiment.

FIG. 4 depicts a top view of the roof insulation drying apparatus, according to an embodiment.

FIG. 5 depicts a rear view of the roof insulation drying apparatus, according to an embodiment.

FIG. 6 depicts a bottom view of the roof insulation drying apparatus, according to an embodiment.

FIG. 7 depicts a side cross-sectional view of the roof insulation drying apparatus, according to an embodiment.

FIG. 8 depicts an exploded top perspective view of the roof insulation drying apparatus, according to an embodiment.

FIG. 9A depicts a top perspective view of the housing of the roof insulation drying apparatus, according to an embodiment.

FIG. 9B depicts a bottom perspective view of the housing of the roof insulation drying apparatus, according to an embodiment.

FIG. 10A depicts a top perspective view of the adapter of the roof insulation drying apparatus, according to an embodiment.

FIG. 10B depicts a top view of the adapter of the roof insulation drying apparatus, according to an embodiment.

FIG. 10C depicts a side view of the adapter of the roof insulation drying apparatus, according to an embodiment.

FIG. 10D depicts a bottom perspective view of the adapter of the roof insulation drying apparatus, according to an embodiment.

FIG. 11A depicts a side view of an extender in use with the roof insulation drying apparatus, according to an embodiment

FIG. 11B depicts a side cross-sectional view of the extender in use with the roof insulation drying apparatus, according to an embodiment.

FIG. 12 depicts a block diagram showing the components of the fan assembly of the roof insulation drying apparatus, according to an embodiment.

### DETAILED DESCRIPTION

The following detailed description refers to the accompanying drawings. Wherever possible, the same reference numbers are used in the drawings and the following description to refer to the same or similar elements. While embodiments of the claimed subject matter may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the claimed subject matter. Instead, the proper scope of the claimed subject matter is defined by the appended claims.

The claimed subject matter improves over the prior art by providing a roof insulation drying apparatus that includes all of the elements necessary to dry the insulation in a roof in a cost effective and measurable manner. The claimed subject matter presents an inexpensively manufactured roof insulation drying apparatus that can be easily and quickly installed in a roof vent. This feature increases the usability of the device for drying storm damaged roofs. Further, the claimed subject matter is disposable and easily discarded so as not to burden the user with unusable byproducts. The claimed subject matter further improves over the prior art by providing a roof insulation drying apparatus that utilizes solar energy, which eliminates the need for a constant power source and results in zero expenses in operating the apparatus.

Furthermore, the claimed subject matter improves over the prior art by targeting the problem of drying wet roof insulation resulting from moisture intrusion due to storm damage, leaks, or other causes. Unlike attic fans, which are primarily designed to ventilate hot air from the attic space to reduce indoor temperatures and alleviate cooling loads, the roof insulation drying apparatus focuses on moisture remediation within the roofing system itself. Attic fans operate by creating airflow in the attic cavity, but they are not effective at extracting moisture from wet insulation materials that are often enclosed within roof assemblies and not directly exposed to the attic space. The roof insulation drying apparatus improves over the prior art by creating a focused airflow that directly interfaces with the wet insulation through the roof vent. By positioning the fan and aperture strategically, it draws moist air out from the insulation layer, promoting faster drying times compared to the general ventilation provided by attic fans.

Moreover, the claimed subject matter improves over the prior art by minimizing its impact on building ventilation. The claimed subject matter operates without disrupting the building's ventilation balance. Attic fans can sometimes create negative pressure in the attic, drawing conditioned air from living spaces or causing back-drafting of combustion appliances. The roof insulation drying apparatus avoids these issues by focusing airflow specifically through the roof vent and affected insulation areas.

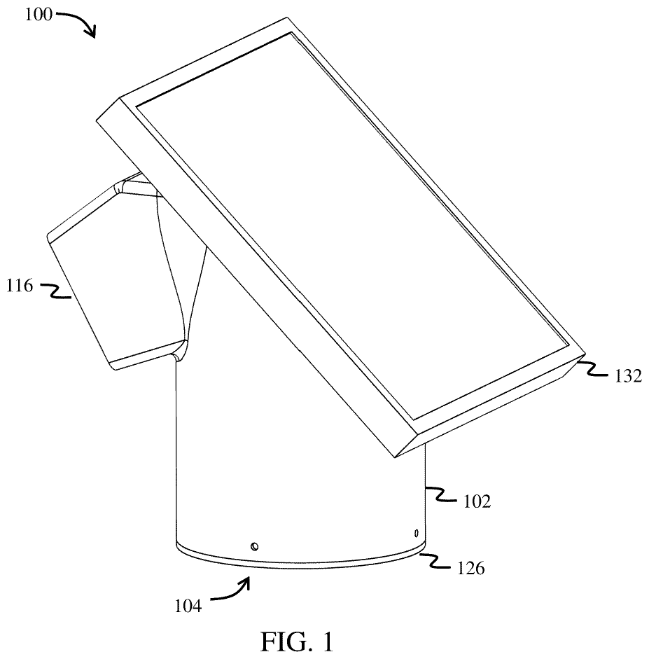

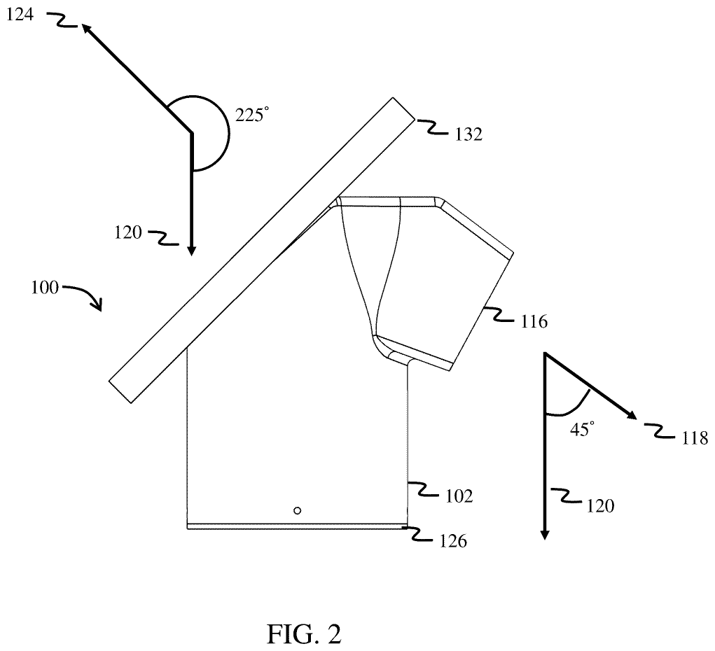

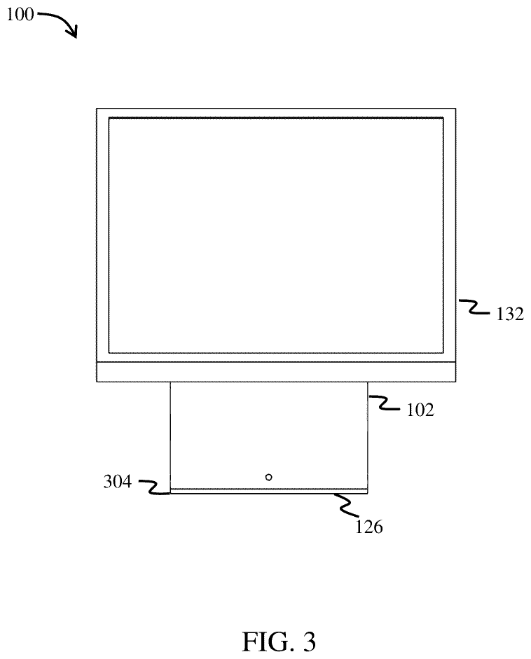

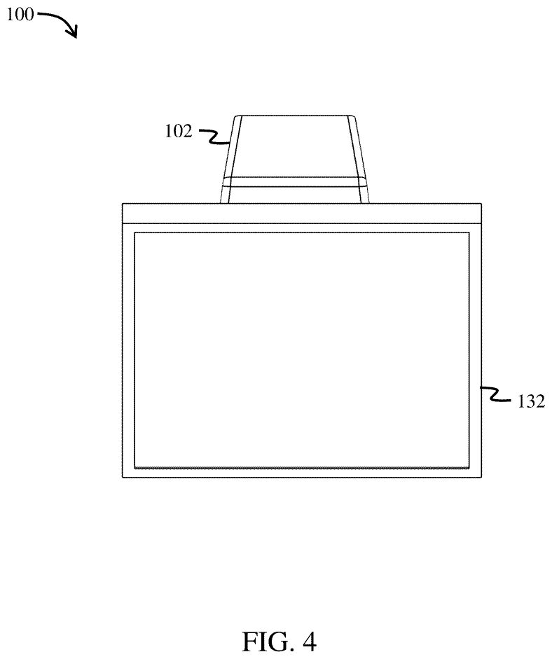

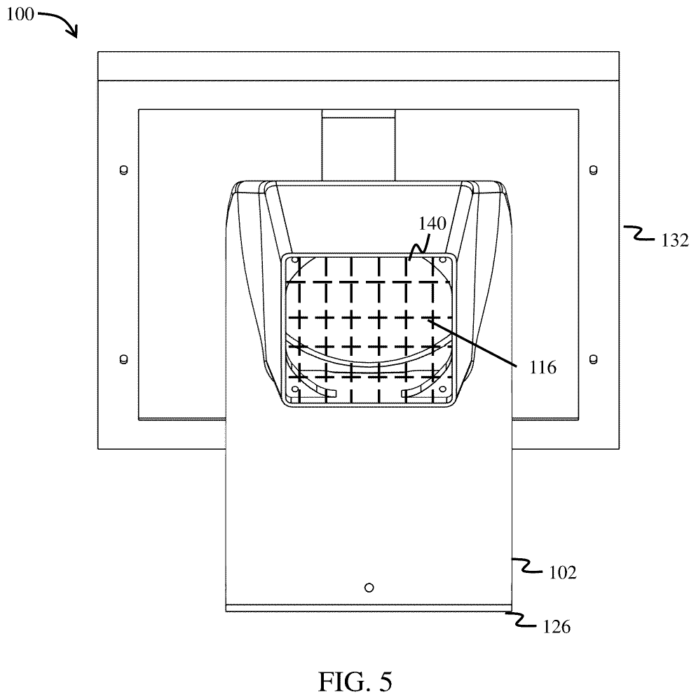

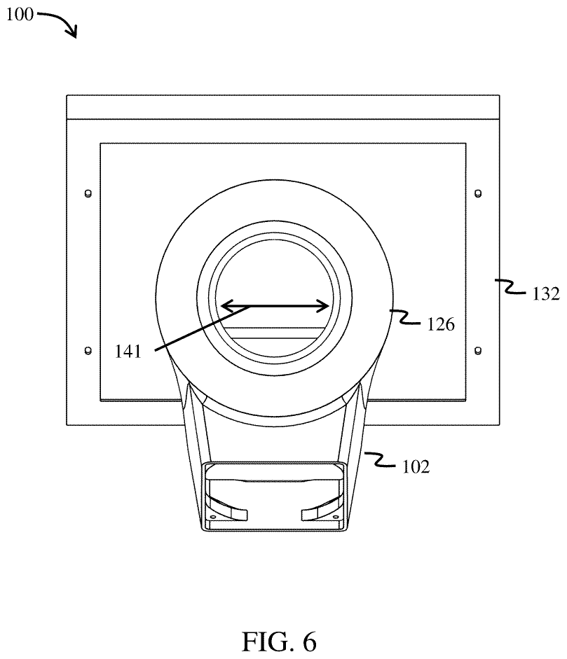

The accompanying drawings, which are incorporated in and constitute a part of this disclosure, illustrate various example embodiments. The claimed roof insulation drying apparatus 100 will now be described with respect to FIGS. 1 through 12.

FIGS. 1-6 depict various views of the roof insulation drying apparatus 100, according to an embodiment. The claimed roof insulation drying apparatus 100 includes a hollow housing 102 having an opening 104 at its base and configured for placement on top of a roof vent 110 on a roof 123, such that an interior volume 112 of the housing is continuous with an interior volume 114 of the roof vent 110. The roof vent 110 may be a one-way or two-way roof vent that provides access to the insulation intended to be dried by the claimed embodiments. The apparatus 100 further includes an aperture 116 on a side of the housing, and a planar surface 122 at the top of the housing, wherein said planar surface faces the opposite direction as the aperture.

The aperture 116 on the side of the housing faces a first direction 118 that is approximately 45-degrees) (45° from the longitudinal axis 120 of the roof vent 110. first Alternatively, the first direction 118 may be approximately 60-degrees) (60° from the longitudinal axis 120 of the roof vent 110. In another alternative, the first direction 118 may be in a range of approximately 45°-60° from the longitudinal axis 120. The planar surface 122 at the top of the housing faces a second direction 124 that is approximately opposite the first direction, or approximately 225-degrees) (225° from the longitudinal axis 120 of the roof vent 110.

The tubular adapter 126 is configured for securing the housing 102 to the roof vent 110. The adapter 126 comprises an outer diameter 131 configured for securely fitting within the opening 104, and an inner diameter 141 configured for securely fitting around the vent 110. When inserted into the housing 102, a portion 304 of the adapter 126 extends out of the housing 102 such that said portion 304 has a diameter equal to the outer diameter of the housing. The apparatus 100 further includes a solar panel 132 secured to the planar surface 122, and a fan assembly 134 conductively coupled to the solar panel 132, such that the solar panel powers the fan. The fan assembly 134 is affixed to the top of the adapter 126.

The hollow housing 102 may be composed of durable plastic, metal, ceramic or any combination of the above. The housing is constructed to withstand various environmental conditions and resist corrosion. The adapter 126 fits within the housing 102 and attaches to the vent 110. A fastener, such as a screw, nail or nut/bolt, may ensure a strong connection between the housing 102 and the adapter 126, and the adapter's inner diameter fits snugly around the roof vent 110, creating an airtight seal. A fastener, such as a screw, nail or nut/bolt, may secure the adapter to the vent by extending though orifice 1019 in the adapter.

The solar panel 132 harnesses solar energy and converts it into electrical power. The apparatus 100 further includes a fan assembly 134 having a fan 1206 conductively coupled to the solar panel 132, which operates exclusively on renewable solar energy, reducing energy consumption and environmental impact. A grate 140 or other permeable membrane may cover the aperture 116. The fan assembly 134 may further include a battery 1208 conductively coupled to a charge controller 1204, which is conductively coupled to the solar panel 132 such that the solar panel charges the battery 1208. Also, the charge controller 1204 may be conductively coupled to the fan 1206 such that the battery 12208 powers the fan 1206.

In operation, the solar panel 132 generates electrical power from sunlight. This power drives the fan 1206, drawing out air from the insulation through the housing's aperture 116. As this air circulates from the roof vent 110 and out of the housing 102, it aids in the drying process of the insulation material within the roofing system. The combination of solar power, ventilation, and controlled air circulation offers an innovative and eco-friendly solution for maintaining dry and efficient roof insulation.

The claimed apparatus 100 offers several advantages, including promoting energy efficiency and sustainability by relying on renewable solar energy, and reducing dependence on traditional power sources. The claimed embodiments also address the need for an efficient and sustainable method of maintaining the effectiveness of roofing insulation systems. The claimed apparatus 100 is designed to harness solar power for the purpose of drying roof insulation materials through controlled ventilation. Additionally, the apparatus 100 ensures that insulation materials remain dry, prolonging their lifespan and preserving the roofing system's integrity. The durable plastic construction enhances longevity and resistance to environmental factors. Installation is simplified, ensuring a secure and reliable connection to the roof vent.

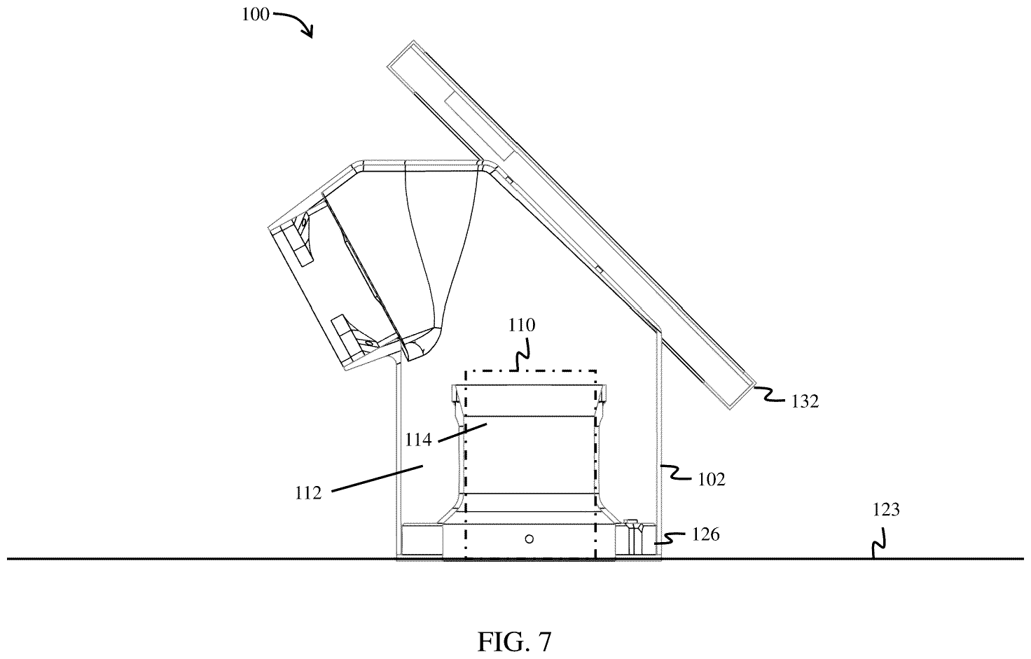

FIG. 7 depicts a side cross-sectional view of the roof insulation drying apparatus 100, according to an embodiment. FIG. 7 shows how the tubular adapter 126 secures the housing 102 to the vent 110 of roof 123. The adapter 126 is held snugly within the opening 104, due to the outer diameter 131 being equivalent or nearly equivalent to the inside diameter of the opening 104. The adapter 126 may be held in place with a friction fit, which can be bolstered by a fastener that fastens the adapter to the housing. The adapter 126 is also securely held around the vent 110 due to the inner diameter 141 being equivalent or nearly equivalent to the outside diameter of the vent 110. FIG. 7 also shows that the interior volume 112 of the housing is continuous with an interior volume 114 of the roof vent 110.

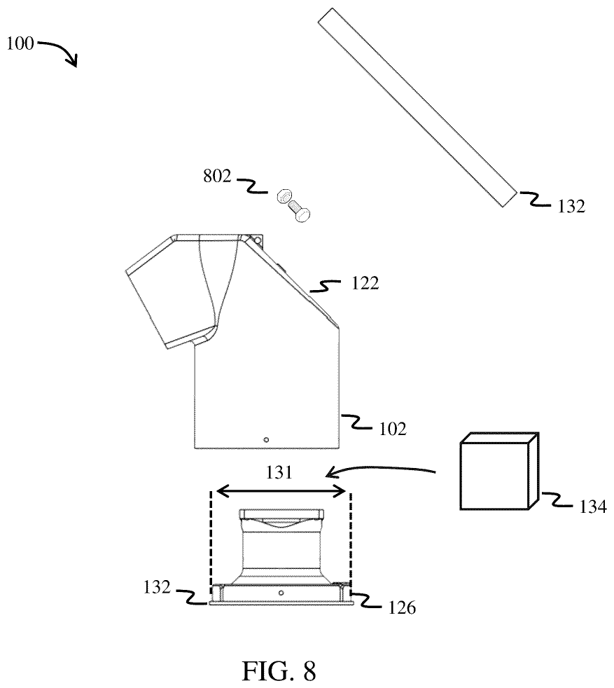

FIG. 8 depicts an exploded top perspective view of the roof insulation drying apparatus 100, according to an embodiment. FIG. 8 shows how the housing 102 fits over the adapter 126 and how the adapter 126 fits within the housing 102. FIG. 8 further shows that the fan assembly 134 is affixed to the top of the adapter 126. A fastener may be used to fasten the adapter 126 to the vent 110 and a fastener 802, such as a nut/bolt, may be used to fasten solar panel 132 to the housing 102 via one or more orifices 806 on the surface 122 into which the fastener may be inserted.

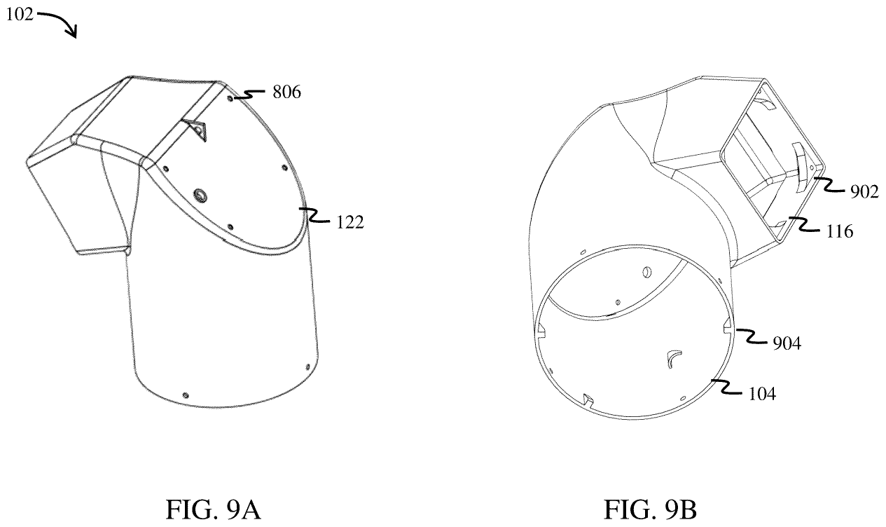

FIGS. 9A and 9B depict different views of the housing 102 of the roof insulation drying apparatus 100, according to an embodiment. FIG. 9A shows another view of the orifices 806 in the surface 122 and provides an orifice for the fastener 802 used to attach the solar panel 132 to the housing 102. FIG. 9B shows that the opening 116 includes one or more gusset flanges 902 located in the corners of the opening 116 of the housing 102. The purpose of the gusset flanges 902 is to provide a method of attachment of the grate within the housing 102 near the opening 116. A fastener, such as a screw or a nut/bolt, may be used to fasten the grate 140 to the housing 102 via the gusset flanges 902 that protrude from the interior surface of the housing, each providing an orifice for the fastener.

FIG. 9B also shows that the opening 104 includes one or more triangular shaped protrusions 904 that protrude from the interior surface of the opening 104 of the housing 102. These protrusions are meant to align with, and to be inserted into, depressions in the adapter 126, which is described below.

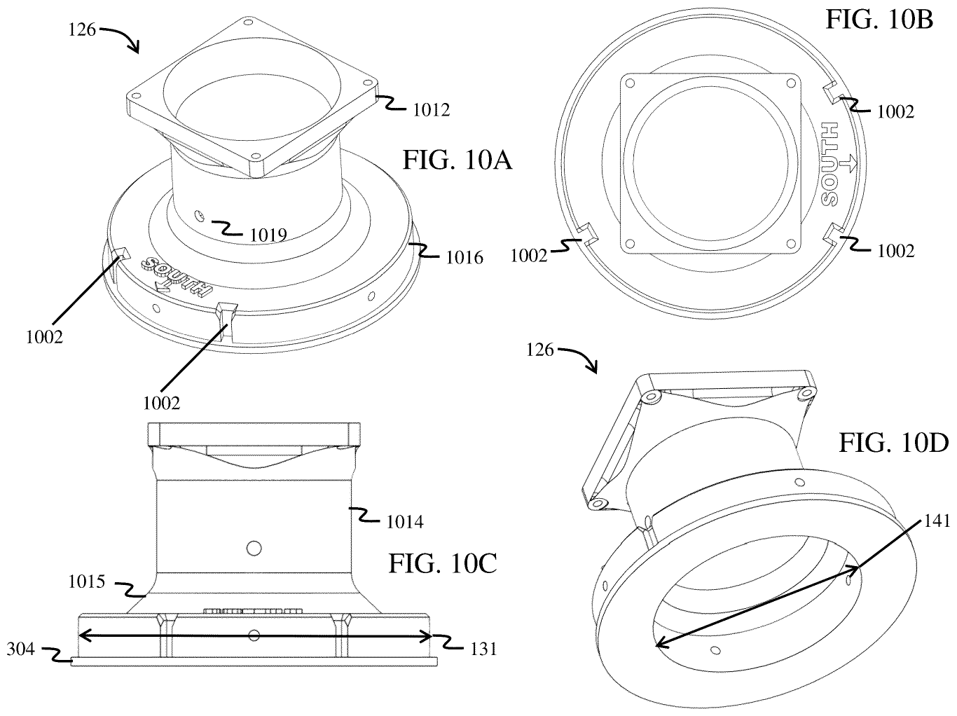

FIGS. 10A-10D depict different views of the adapter 126 of the roof insulation drying apparatus 100, according to an embodiment. The adapter 126 comprises a tubular element 1014 with a rectangular flange 1012 having a diagonal length greater than the outer diameter of the tubular element. At its base, the tubular element is attached to a disc element 1016 having an outer diameter 131 greater than the diameter of the tubular element. The transition 115 between the tubular element and disc element flares outward with an increasing radius so as to provide a smooth curved surface. At the base of the disc element 1016 is a lip 304 that has a greater outer diameter than the disc element.

FIGS. 10A-10D show that the adapter 126 comprises an outer diameter 131 configured for securely fitting within the opening 104, and an inner diameter 141 configured for securely fitting around the vent 110. When inserted into the housing 102, a portion 304 of the adapter 126 extends out of the housing 102 such that said portion 304 has a diameter equal to the outer diameter of the housing 102. FIGS. 10A-10D also show that the disc element 1016 of the adapter 126 comprises one or more depressions 1002 that are sized and shaped to mate with the triangular shaped protrusions 904 that protrude from the interior surface of the opening 104 of the housing 102. These protrusions are meant to align with, and to be inserted into, the depressions 1002 in the adapter 126 so as to provide a secure fit between the housing and the adapter and to prevent rotation of the housing around the adapter.

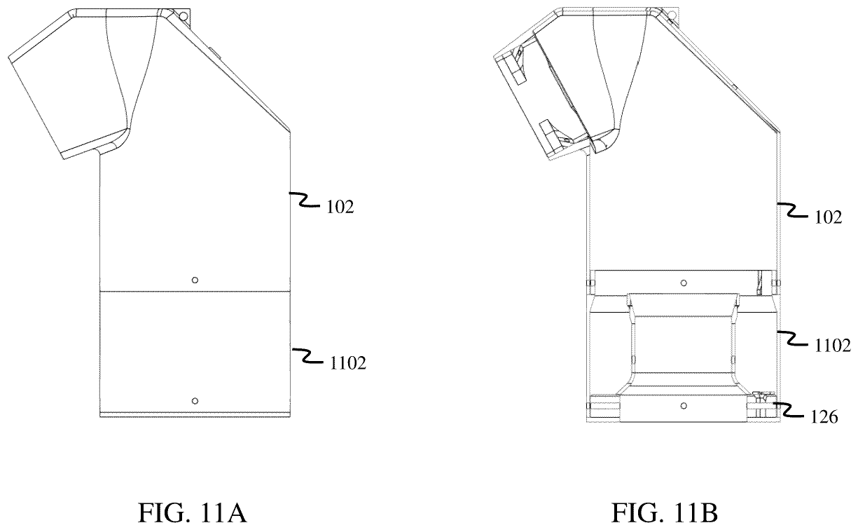

FIGS. 11A and 11B depict different views of an extender 1102 in use with the housing 102 of the roof insulation drying apparatus 100, according to an embodiment. The extender 1102 is generally a tubular shaped element that is placed around and top of the adapter 126, similar to the housing, such that the housing 102 is placed on top of, and attaches to, the extender. Like the housing 102, the extender 1102 has an interior diameter that matches the outside diameter of the adapter 126 such that the adapter fits snugly and securely within the extender 1102. A fastener, such as a screw, nail or nut/bolt, may ensure a strong connection between the extender 1102 and the adapter 126. Once the extender 1102 is coupled with the adapter 126, the housing 102 may be coupled to the top of the extender. A fastener, such as a screw, nail or nut/bolt, may ensure a strong connection between the extender 1102 and the adapter 126. The purpose of the extender is to raise the elevation of the housing 102 in situations where there may be a surrounding floor covering, such as tile, or in situations where it is desired to avoid shadows from barrier walls, HVAC units, etc.

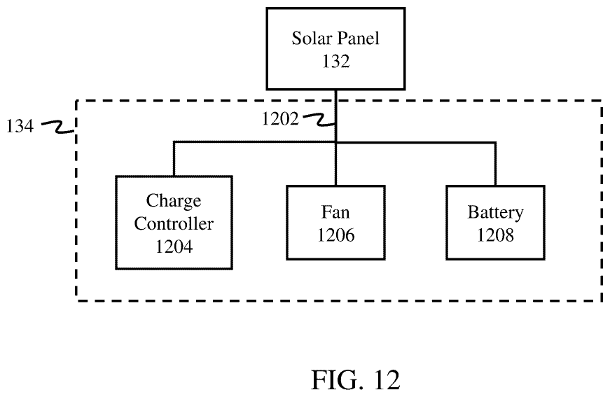

FIG. 12 depicts a block diagram showing the components of the fan assembly 134 of the roof insulation drying apparatus 100, according to an embodiment. The fan assembly 134 is designed to facilitate the removal of moisture-laden air from the wet insulation through the roof vent 110. The assembly comprises the fan 1206, the battery 1208, and the charge controller 1204, all interconnected via the conductor 1202 to the solar panel 132. The solar panel 132, mounted on the planar surface 122 of the housing 102, serves as the primary power source for the fan assembly 134. It harnesses solar energy and converts it into electrical power, which is transmitted through the conductor 1202. The conductor 1202 is an electrical connection that links the solar panel 132 to the charge controller 1204, ensuring the efficient flow of electricity within the system.

The charge controller 1204 that regulates the voltage and current received from the solar panel 132. It protects the battery 1208 from overcharging by controlling the charging process, thereby prolonging the battery's lifespan and maintaining optimal performance. The charge controller 1204 ensures that the electrical energy is stored safely and efficiently within the battery 1208. The battery 1208 functions as an energy storage unit, accumulating electrical power generated by the solar panel 132 during periods of sunlight. This stored energy allows the fan 1206 to operate continuously, even during times of low solar irradiance, such as cloudy weather or nighttime. By storing excess energy, the battery 1208 ensures that the apparatus 100 maintains consistent airflow to dry the insulation effectively.

The fan 1206 is the active mechanical component responsible for generating airflow. Powered by the battery 1208, it creates a suction effect that draws moist air from the wet insulation layer up through the roof vent 110 and into the interior volume 112 of the housing 102. The air is then expelled through the aperture 116, which faces a direction approximately 45 degrees from the longitudinal axis 120 of the roof vent 110. The continuous operation of the fan 1206 accelerates the drying process by promoting constant air exchange.

Each component of the roof insulation drying apparatus 100 may be selected for its material properties to ensure durability, efficiency, and cost-effectiveness. The hollow housing 102 may be constructed from durable plastic materials such as high-density polyethylene (HDPE) or polyvinyl chloride (PVC), which provide resistance to environmental factors like UV radiation, temperature fluctuations, and moisture. The tubular adapter 126, may also be made from the same durable plastics as the housing. This material consistency aids in preventing differential expansion and contraction due to temperature changes, ensuring a tight seal between the adapter 126 and both the housing 102 and the roof vent 110. In some embodiments, the adapter 126 could be made from metals like aluminum or stainless steel for added strength and rigidity, especially in installations where additional support is necessary.

The solar panel 132 affixed to the planar surface 122 of the housing 102 consists of photovoltaic cells encapsulated within protective layers. The front layer may be tempered glass, providing impact resistance and protection from hail or debris. The backing material may be a durable polymer, and the frame may be made of anodized aluminum, which offers corrosion resistance and structural support. The solar panel 132 is designed to withstand harsh weather conditions while efficiently converting sunlight into electrical energy.

The fan 1206 within the fan assembly 134 is composed of materials such as acrylonitrile butadiene styrene (ABS) plastic for the fan blades due to its toughness and resistance to impact. The motor components of the fan 1206 may include copper windings and steel shafts, chosen for their electrical conductivity and mechanical strength.

The battery 1208 in the fan assembly 134 may be a rechargeable lithium-ion or lead-acid battery, selected based on factors such as energy density, weight, cost, and temperature performance. The battery casing may be made from robust plastics like polycarbonate or ABS to protect against moisture ingress and physical damage.

The charge controller 1204, which regulates the voltage and current from the solar panel 132 to the battery 1208, contains electronic components mounted on a printed circuit board (PCB) made of materials such as fiberglass-reinforced epoxy resin. The enclosure for the charge controller 1204 may be made from sealed plastic or metal to shield sensitive electronics from environmental exposure, including moisture and dust. The conductor 1202 connecting the solar panel 132, charge controller 1204, battery 1208, and fan 1206 consists of insulated electrical wiring. The insulation material may be cross-linked polyethylene (XLPE) or polyvinyl chloride (PVC), both of which offer excellent resistance to heat, sunlight, and weathering.

The grate 140 covering the aperture 116 may be made from corrosion-resistant metals such as stainless steel or aluminum, providing durability and preventing rust. Alternatively, UV-resistant plastic materials like nylon or polycarbonate may be used for the grate 140 to reduce weight while still offering protection against debris and pests entering the housing 102.

By thoughtfully selecting materials for each component based on their physical properties and environmental resistance, the roof insulation drying apparatus 100 achieves a balance of performance, durability, and cost-effectiveness. These material choices contribute to the apparatus's ability to operate reliably in diverse weather conditions, effectively drying wet roof insulation and extending the lifespan of roofing systems.

Embodiments may be described above with reference to functions or acts, which comprise methods. The functions/acts noted above may occur out of the order as shown or described. For example, two functions/acts shown or described in succession may in fact be executed substantially concurrently or the functions/acts may sometimes be executed in the reverse order, depending upon the functionality/acts involved. While certain embodiments have been described, other embodiments may exist. Further, the disclosed methods' functions/acts may be modified in any manner, including by reordering functions/acts and/or inserting or deleting functions/acts, without departing from the spirit of the claimed subject matter.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A roof insulation drying apparatus, comprising:
a) a hollow housing having an opening at its base and configured for placement on top of a roof vent on a roof, such that an interior volume of the housing is continuous with an interior volume of the roof vent;
b) an aperture on a side of the housing, wherein said aperture faces a first direction that is approximately 45-degrees from the longitudinal axis of the roof vent;
c) a planar surface at a top of the housing, wherein said planar surface faces a second direction that is approximately opposite the first direction;
d) a tubular adapter configured for securing the housing to the roof vent, the adapter comprising an outer diameter configured for securely fitting within the opening, and an inner diameter configured for securely fitting around the roof vent;
e) a solar panel secured to the planar surface; and
f) a fan conductively coupled to the solar panel, such that the solar panel powers the fan.

2. The roof insulation drying apparatus of claim 1, wherein the housing is composed of plastic.

3. The roof insulation drying apparatus of claim 2, wherein the aperture is approximately square shaped.

4. The roof insulation drying apparatus of claim 3, further comprising a grate covering the aperture.

5. The roof insulation drying apparatus of claim 4, wherein the tubular adapter is configured to fit inside of the opening, such that a portion of the tubular adapter extends out of the opening.

6. The roof insulation drying apparatus of claim 5, further comprising a fastener for fastening the solar panel to the housing.

7. The roof insulation drying apparatus of claim 6, further comprising a conductor for conductively coupling the solar panel to the fan.

8. The roof insulation drying apparatus of claim 7, further comprising a battery conductively coupled to a charge controller, which is conductively coupled to the solar panel such that the solar panel charges the battery.

9. The roof insulation drying apparatus of claim 8, wherein the charge controller is conductively coupled to the fan such that the battery powers the fan.

10. The roof insulation drying apparatus of claim 9, further comprising a fastener for securing the adapter to the vent.

11. A roof insulation drying apparatus, comprising:
a) a hollow housing having an opening at its base and configured for placement on top of a roof vent on a roof, such that an interior volume of the housing is continuous with an interior volume of the roof vent;
b) an aperture on a side of the housing, wherein said aperture faces a first direction that is approximately 45-degrees from the longitudinal axis of the roof vent;
c) a planar surface at a top of the housing, wherein said planar surface faces a second direction that is approximately opposite the first direction;
d) a tubular adapter configured for securing the housing to the roof vent, the adapter comprising an outer diameter configured for securely fitting within the opening, and an inner diameter configured for securely fitting around the roof vent, the tubular adapter further including a portion having an outer diameter equivalent to an outer diameter of the opening;
e) a solar panel secured to the planar surface; and
f) a fan conductively coupled to the solar panel, such that the solar panel powers the fan.

12. The roof insulation drying apparatus of claim 11, wherein the housing is composed of plastic.

13. The roof insulation drying apparatus of claim 12, wherein the aperture is approximately square shaped.

14. The roof insulation drying apparatus of claim 13, further comprising a grate covering the aperture.

15. The roof insulation drying apparatus of claim 14, wherein the portion having an outer diameter equivalent to an outer diameter of the opening portion extends out of the opening.

16. The roof insulation drying apparatus of claim 15, further comprising a fastener for fastening the solar panel to the housing.

17. The roof insulation drying apparatus of claim 16, further comprising a conductor for conductively coupling the solar panel to the fan.

18. The roof insulation drying apparatus of claim 17, further comprising a battery conductively coupled to a charge controller, which is conductively coupled to the solar panel such that the solar panel charges the battery.

19. The roof insulation drying apparatus of claim 18, wherein the charge controller is conductively coupled to the fan such that the battery powers the fan.

20. The roof insulation drying apparatus of claim 19, further comprising a fastener for securing the adapter to the vent.
